(19) United States
(12) Patent Application Publication
(10) Pub. No.: US 2009/0084739 A1
(43) Pub. Date: Apr. 2, 2009

(54) Gas cylinder containment system

(76) Inventors: Robert Shock, Meriden, CT (US); William Bertuleit, Berlin, CT (US); Steven Weiss, Naugatuck, CT (US)

Correspondence Address: RATNERPRESTIA, P.O. BOX 980, VALLEY FORGE, PA, 19482, US

(21) Appl. No.: 11/904,847

(22) Filed: Sep. 28, 2007

(51) Int. Cl. A47B 81/00; E05B 73/00

(52) U.S. Cl. 211/4; 211/75

(57) ABSTRACT

A pressurized cylinder containment unit is provided. The pressurized cylinder containment unit comprises a support structure including means for receiving a shelf. The shelf receiving means is/are defined along at least a portion of a height dimension of the support structure. At least one shelf is provided for supporting the one or more pressurized cylinders. The at least one shelf is moveably positionable along the height dimension of the support structure. The at least one shelf includes mounting means for selectively mounting to the shelf receiving means of the support structure at different height elevations.

### FIELD OF THE INVENTION

The disclosed invention relates to a unit for retaining and storing pressurized gas cylinders.

### BACKGROUND OF THE INVENTION

Hazards associated with compressed gases include oxygen displacement, fires, explosions, and toxic gas exposures, as well as the physical hazards associated with high pressure systems. Special storage, use, and handling precautions for pressurized gas cylinders are necessary in order to prevent those hazards. There is a need to develop and improve containment systems for pressurized gas cylinders in the interests of safety and convenience.

### SUMMARY OF THE INVENTION

According to one aspect of the invention, a pressurized cylinder containment unit is provided. The pressurized cylinder containment unit comprises a support structure including means for receiving a shelf. The shelf receiving means is/are defined along at least a portion of a height dimension of the support structure. At least one shelf is provided for supporting the one or more pressurized cylinders. The at least one shelf is moveably positionable along the height dimension of the support structure. The at least one shelf includes mounting means for selectively mounting to the shelf receiving means of the support structure at different height elevations.

According to another aspect of the invention, the support structure defines a containment space for accommodating one or more pressurized cylinders. An arm is moveably coupled to the support structure. The arm is moveable between an open position for providing selective access to the one or more pressurized cylinders positioned within the containment space and a closed position for retaining the pressurized cylinders within the containment space.

According to yet another aspect of the invention, the unit comprises a plurality of shelves for supporting multiple pressurized cylinders, wherein each shelf corresponds to one or more containment spaces. Each shelf is mountable to the support structure at different height elevations.

### BRIEF DESCRIPTION OF THE DRAWINGS

The invention is best understood from the following detailed description when read in connection with the accompanying drawing. It is emphasized that, according to common practice, the various features of the drawing may not be to scale. Included in the drawing are the following figures:

FIG. 1A is a perspective view of a cylinder containment unit according to a first exemplary embodiment of the invention;

FIG. 1B is a right side elevation view of the cylinder containment unit of FIG. 1A;

FIG. 1C is a front elevation view of the cylinder containment unit of FIG. 1A;

FIG. 1D is a top plan view of the cylinder containment unit of FIG. 1A;

FIG. 1E is a partial cut-away view of a segment of the cylinder containment unit of FIG. 1B;

FIG. 2A is a perspective view of a cylinder containment unit according to a second exemplary embodiment of the invention;

FIG. 2B is a right side elevation view of the cylinder containment unit of FIG. 2A;

FIG. 2C is a front elevation view of the cylinder containment unit of FIG. 2A;

FIG. 2D is a top plan view of the cylinder containment unit of FIG. 2A;

FIG. 3A is a perspective view of a cylinder containment unit according to a third exemplary embodiment of the invention;

FIG. 3B is a right side elevation view of the cylinder containment unit of FIG. 3A;

FIG. 3C is a front elevation view of the cylinder containment unit of FIG. 3A;

FIG. 3D is a rear elevation view of the cylinder containment unit of FIG. 3A;

FIG. 3E is a top plan view of the cylinder containment unit of FIG. 3A;

FIG. 4A is a perspective view from the top right side of a cylinder containment unit according to a fourth exemplary embodiment of the invention;

FIG. 4B is a perspective view from the top left side of the cylinder containment unit of FIG. 4A;

FIG. 4C is a top plan view of the cylinder containment unit of FIG. 4A;

FIG. 4D is a rear elevation view of the cylinder containment unit of FIG. 4A;

FIG. 4E is a right side elevation view of the cylinder containment unit of FIG. 4A; and

FIG. 4F is a front elevation view of the cylinder containment unit of FIG. 4A.

### DETAILED DESCRIPTION OF THE INVENTION

The invention is best understood from the following detailed description when read in connection with the accompanying drawing, which shows exemplary embodiments of the invention selected for illustrative purposes. The invention will be illustrated with reference to the figures. Such figures are intended to be illustrative rather than limiting and are included herewith to facilitate the explanation of the present invention. In the various embodiments like item numbers represent substantially similar features.

Referring generally to the figures, and according to one aspect of the invention, a pressurized cylinder containment unit 100, 200, 300 and 400 is provided. The pressurized cylinder containment unit 100, 200, 300 and 400 comprises a support structure 104, 204, 304 and 404 including means 113 for receiving a shelf 110, 210, 310 and 410. The shelf receiving means 113 is/are defined along at least a portion of a height dimension of the support structure 104, 204, 304 and 404. At least one shelf 110, 210, 310 and 410 is provided for supporting the one or more pressurized cylinders 102, 202 and 302. The at least one shelf 110, 210, 310 and 410 is moveably positionable along the height dimension of the support structure 104, 204, 304 and 404. The at least one shelf 110, 210, 310 and 410 includes mounting means 114, 414 for selectively mounting to the shelf receiving means 113 of the support structure 104, 204, 304 and 404 at different height elevations H1-H5.

According to another aspect of the invention, the support structure 104 defines a containment space ‘S’ for accommodating one or more pressurized cylinders 102. An arm 120 is moveably coupled to the support structure 104. The arm 120 is moveable between an open position for providing selective access to the one or more pressurized cylinders 102 positioned within the containment space ‘S’ and a closed position for retaining the pressurized cylinders 102 within the containment space ‘S.’

According to yet another aspect of the invention, the unit 400 comprises a plurality of shelves 410A-D for supporting multiple pressurized cylinders, wherein each shelf 410A-D corresponds to a containment space ‘S’ and is mountable to the support structure 404 at different height elevations H1-H5.

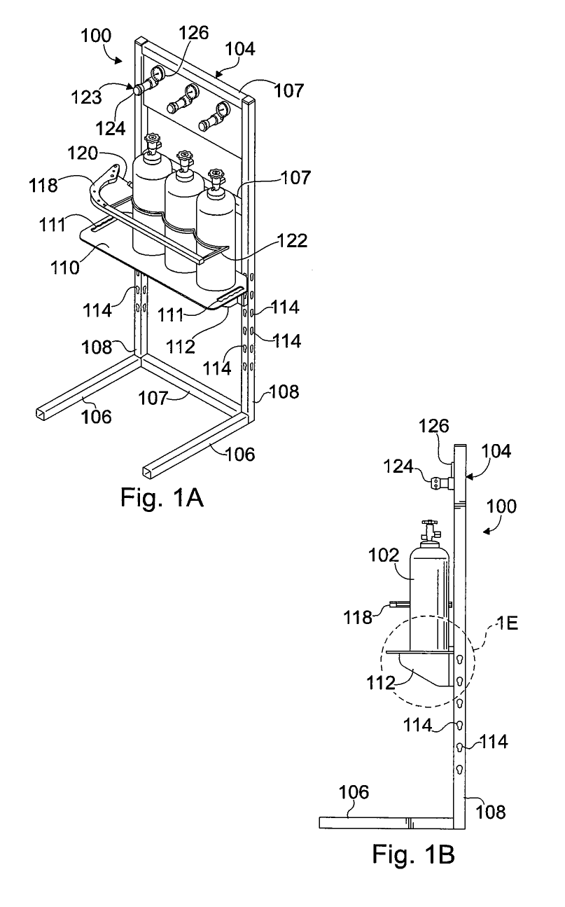

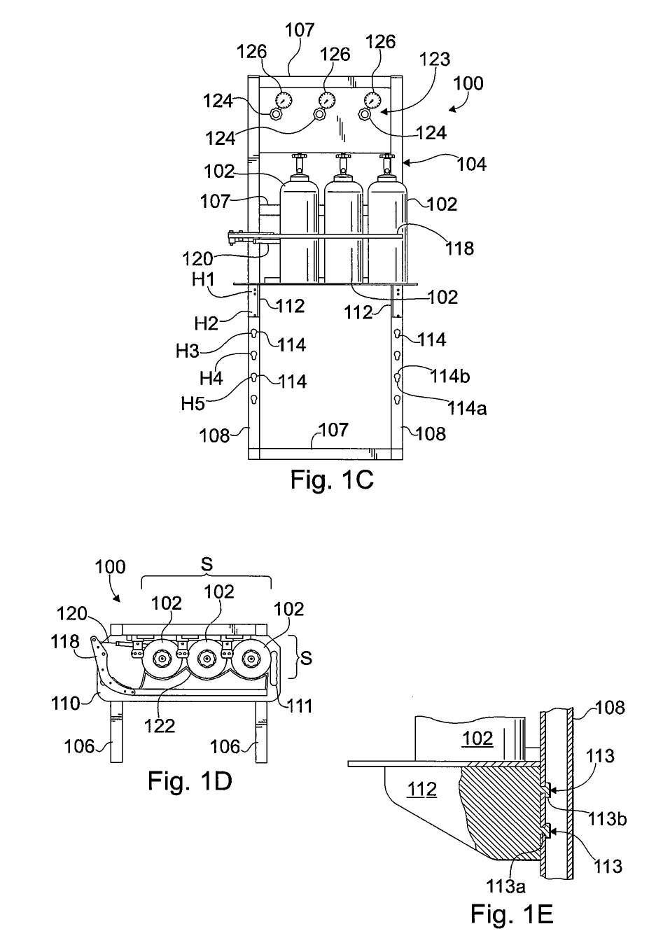

Referring now to the individual drawing figures, FIGS. 1A-1D depict perspective, right side elevation, front elevation and top plan views, respectively, of a cylinder containment unit 100 (hereinafter unit 100) according to a first exemplary embodiment of the invention. The cylinder containment unit 100 includes a support structure 104 for supporting the weight of one or more gas cylinders 102 (three shown). Support structure 104 includes two base members 106 (e.g., legs) for contacting a floor surface (not shown). A vertical member 108 is mounted to each base member 106 to extend substantially perpendicular with respect to base member 106. Three (3) cross-members 107 are mounted between the opposing vertical members 108. The support structure may include any number or arrangement of members 106, 107 and 108.

Although not shown, support structure 104 may include means, such as a flange or a hole for receiving a bolt, for mounting to a wall and/or a floor surface.

Members 106, 107 and 108 are optionally formed from hollow steel tubes having a square cross-sectional shape. It should be understood that the material properties, shape and size of members 106, 107 and 108 may vary. Members 106, 107 and 108 are optionally welded together for enhanced structural integrity. It should also be understood that members 106, 107 and 108 may be fastened together in any fashion known in the art.

A shelf 110 is releasably mounted to support structure 104. One or more gas cylinders 102 are positioned on a flat surface of shelf 110. Although not shown, a structure may be positioned on the support surface of shelf 110 for retaining the base of one or more gas cylinders 102 in place. The shelf 110 includes two hand grips 111 positioned on opposing sides thereof for manual handing of shelf 110.

Two (2) brackets 112 are mounted on opposing sides of shelf 110. In use, brackets 112 bear on vertical members 108, thereby transferring a portion of the weight of cylinders 102 onto support structure 104. The brackets 112 may be mounted to or integral with shelf 110. According to one aspect of the invention, shelf 110 can support 250 pounds. It should be understood that unit 100 may be tailored to support any desired weight.

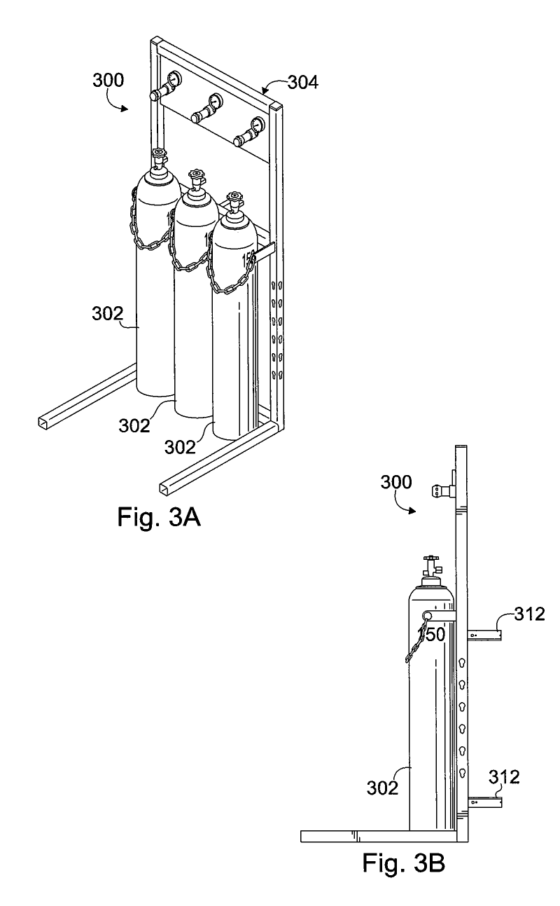

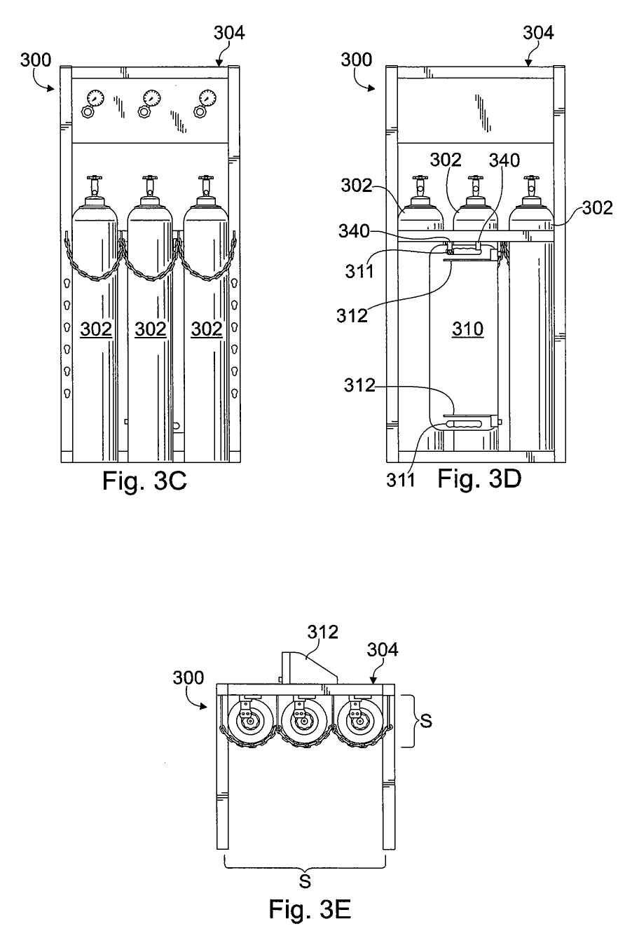

The shelf 110 may be selectively positioned at any desired height elevation H1-H5 along support structure 104. The height elevation H1, H2, H3, H4 or H5 ultimately selected by the user is dependent upon the height of one or more cylinders 102. For example, shelf 110 may be positioned at height elevation Hi to accommodate short cylinders 102 (as best shown in FIGS. 1A-1C), and shelf 110 may be positioned at height elevation H5 to accommodate tall cylinders 102. Alternatively, shelf 110 may be omitted altogether to accommodate very tall cylinders 102, as best shown in FIGS. 3A-3E. As described in greater detail with reference to FIG. 1B, height elevations H1-H5 correspond to shelf receiving means disposed along the height dimension of the vertical members 108.

The unit 100 is adapted to safely store a wide variety of gas cylinders 102 of varying heights. As noted in the Background section, special storage, use, and handling precautions for pressurized gas cylinders are necessary in order to avoid hazards. Unit 100 presents a is safe and convenient structure for storing gas cylinders 102.

Referring still to FIGS. 1A-1E, each bracket 112 includes shelf mounting means, in the form of two posts 113 (see FIG. 1E) for mounting to support structure 104. Each post 113 includes a small diameter post portion 113A extending from bracket 112, and a large diameter post portion 113B extending from small diameter portion 113A. The post portions 113A and 113B are axially aligned, according to one aspect of the invention. Those skilled in the art will recognize that the shelf mounting means may differ from that shown and described herein, without departing from the scope of the invention. By way of non-limiting example, the shelf mounting means may also be in the form of mechanical fasteners, apertures, hooks, locks, adhesive, chains, gears, magnets, or any other means for mounting shelf 110 to support structure 104.

The support structure 104 includes shelf receiving means that are configured to be releasably engageable with the aforementioned shelf mounting means (e.g., posts 113).

According to the exemplary embodiment illustrated in FIGS. 1A-1E, the shelf receiving means are provided in the form of a plurality of apertures 114. The apertures 114 are formed in vertical members 108. The apertures 114 are positioned along the height elevation H1-H5 of the support structure 104. Each height elevation H1-H5 is associated with four (4) apertures 114, i.e., two (2) vertically adjacent apertures 114 per vertical member 108. Four (4) posts 113 of shelf 110 may be inserted through the four (4) apertures 114 at any selected height elevation H1-H5.

Each aperture 114 includes a reverse key-hole shaped slot for receiving posts 113. As best shown in FIG. 1C, each key hole slot is defined by a large diameter portion 114B positioned above a small diameter portion 114A. The large diameter portion 114B is sized to receive portion 113B of post 113, and small diameter portion 114A is sized to receive portion 113A of post 113. Those skilled in the art will recognize that the shelf receiving means may differ from that shown and described herein, without departing from the scope of the invention. By way of non-limiting example, the shelf receiving means may also be in the form of mechanical fasteners, apertures, gears, hooks, locks, adhesive, chains, magnets, or any other means for receiving and supporting shelf 110.

According to one exemplary use of the invention, the four (4) posts 113 of shelf 110 are aligned with four (4) corresponding apertures 114 of support structure 104 at a predetermined height elevation H1, H2, H3, H4 or H5. Each post portion 113B is inserted through large diameter portion 114B of apertures 114. The shelf 110 is then slid in the downward vertical direction by virtue of the clearance between small diameter portion 114A and post portion 113A. The post portions 113A ultimately bear against small diameter portion 114A of apertures 114. The post portions 113B also bear against the interior surfaces of vertical members 108. Other ways of releasably attaching shelf 110 to support structure 104 are contemplated and known to one skilled in the art.

To remove shelf 110 or reposition shelf 110 at another height elevation, shelf 110 is first translated in the upward vertical direction until each post portion 113B is aligned with a respective aperture portion 114B. The shelf 110 is then-translated away from support structure 104 until post portion 113B clears large diameter portion 114B. The shelf 110 may then be repositioned at another height elevation H1-H5, pursuant to the steps outlined above.

According to an alternative embodiment not illustrated herein, the brackets are slideably mounted to the vertical members, such that the shelf is selectively moveable along the height dimension of the vertical members, without removing the shelf from the unit. According to another alternative embodiment not illustrated herein, the unit may include a motor or other apparatus for raising and lowering the shelf along the height dimension of the support structure.

The gas cylinders 102 are retained in a containment space ‘S’ by a moveable arm 118. The containment space ‘S’ is the area defined between moveable arm 118 and support structure 104 for accommodating one or more gas cylinders, according to one exemplary embodiment of the invention. The moveable arm 118 is moveable between an open position (not shown) for providing selective access to pressurized cylinders 102 positioned within the containment space ‘S’ and a closed position (see all FIGS. 1A-1D) for retaining pressurized cylinders 102 within the containment space‘S.’

A retainer 122 mounted to arm 118 bears against the cylindrical surface of one or more gas cylinders 102, thereby retaining gas cylinders 102 in a fixed position. The retainer 122 may be formed from a deformable material, such as foam or plastic, for example, to accommodate cylinders 102 of various shapes and sizes. The retainer 122 may be configured to return to its original shape subsequent to deformation.

According to one aspect of the invention, moveable arm 118 is hydraulically actuated to provide selective access to cylinders 102. Specifically, according to this embodiment, a hydraulic piston 120 is mounted between support structure 104 and moveable arm 118. The piston 120 may be manually operable, if so desired. The moveable arm 118 may be made moveable by any system known in the art.

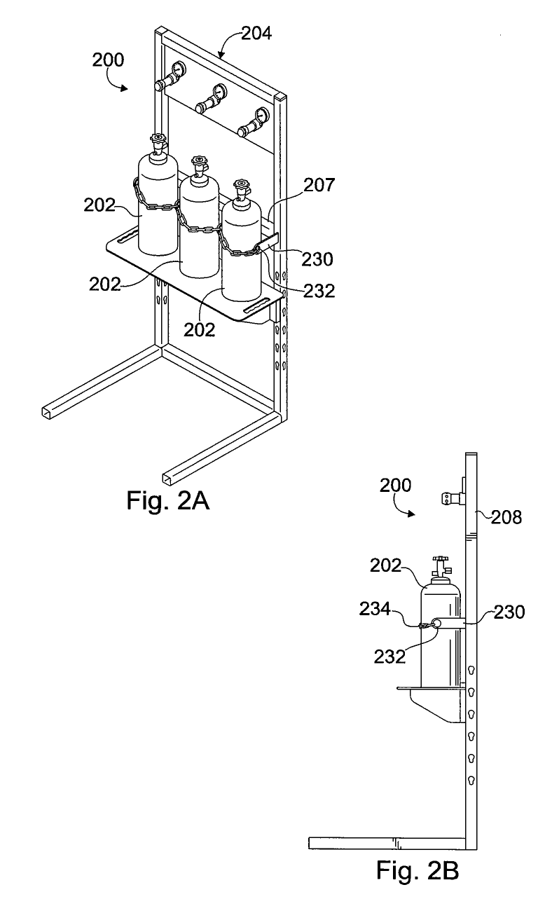

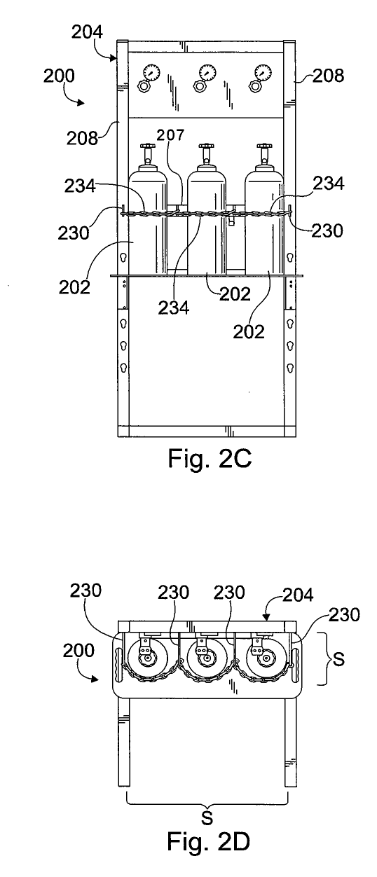

Although not shown piston 120 (and/or arm 118) may be releasably fastened to support structure 104, such that the vertical position of piston 120 (and/or arm 118) may be adjusted with the height elevation of shelf 110. Accordingly, the support structure may include means for mounting the piston 120 (and/or arm 118) along its height dimension. Alternatively, as best shown in FIGS. 2A-2D, a chain may be utilized to retain the gas cylinders in a fixed positioned within the containment space ‘S.’

The unit 100 includes a user control interface 123 for controlling the release of gas from one or more gas cylinders 102. The user control interface 123 includes a plurality of pressure regulators 124, and a pressure gauge 126 associated with each pressure regulator 124 for indicating the pressure setting of the pressure regulator 124. Although not shown, one or more flexible hoses extend between each cylinder 102 and each pressure regulator 124 for carrying pressurized gas between the cylinders 102 and the pressure regulator 124. It should be understood that user control interface 123 is an optional feature of unit 100.

FIGS. 2A-2D depict perspective, right side elevation, front elevation and top plan views, respectively, of a cylinder containment unit 200 (hereinafter unit 200) according to a second exemplary embodiment of the invention. Unit 200 is similar to unit 100, with the exception that cylinders 202 are retained in containment space ‘S’ by chains 234 in lieu of a moveable arm 118.

According to this exemplary embodiment, a series of flanges 230 extend from support structure 204. The flanges 230 are mounted to cross members 207 and vertical members 108. The flanges 230 may be releasably mounted to support structure 204, such that they may be moveably positioned along the height of support structure 204. Accordingly, a series of flange receiving means (not shown) may be positioned along the height dimension of support structure 104 for receiving flanges 230 at multiple height elevations.

Each flange 230 includes an aperture 232 sized to receive one or more chains 234. The chain 234 may be fastened to itself or aperture 232 for retaining cylinders 202 in a fixed position. Although not shown, a padlock may secure each chain 234. Those skilled in the art will recognize that equivalents to chain 234 exist.

FIGS. 3A-3E depict perspective, right side elevation, front elevation, rear elevation and top plan views, respectively, of a cylinder containment unit 300 (hereinafter unit 300) according to a third exemplary embodiment of the invention. Unit 300 is similar to unit 200, with the exception that support structure 304 includes hangers 340 for storing a shelf 310 (shelf 310 includes brackets 312). When shelf 310 is not in use, shelf 310 may be conveniently stored by hanging hand grip 311 of shelf 310 on hangers 340, as shown in FIG. 3D.

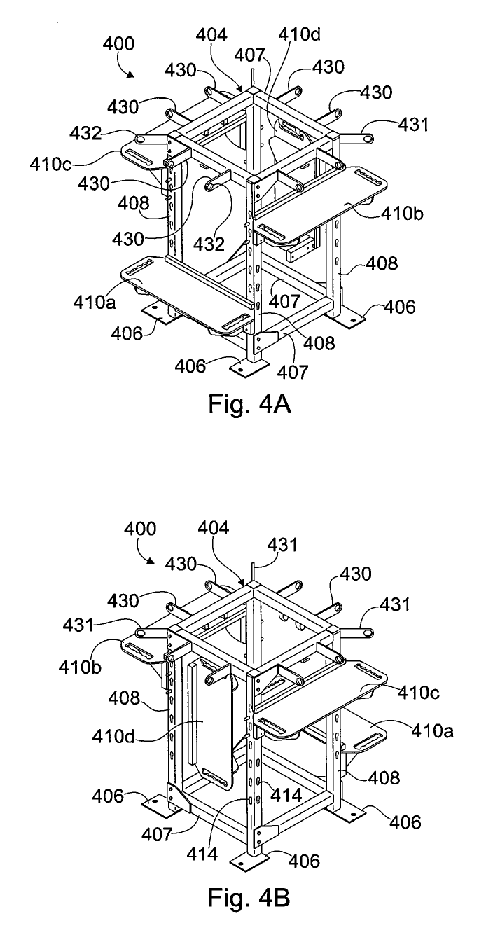

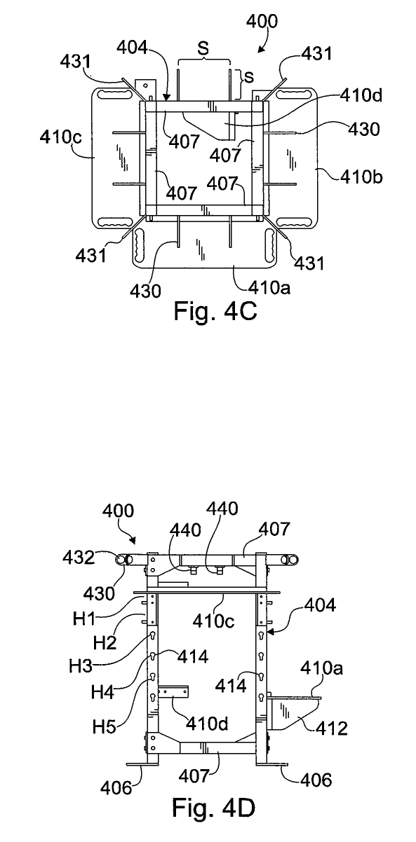

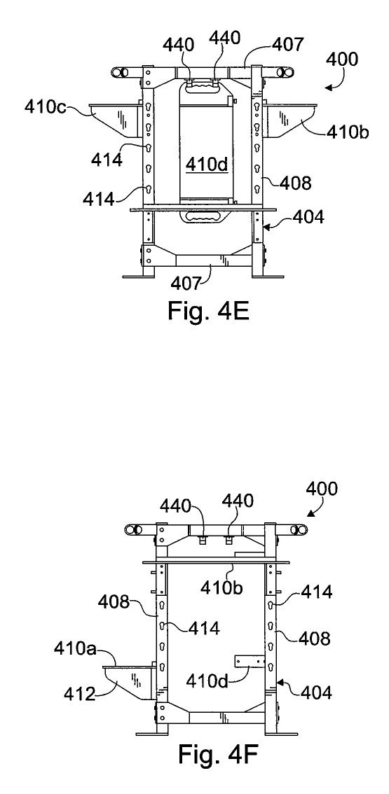

FIGS. 4A-4F depict top right perspective, top left perspective, top plan, rear elevation, right elevation, and front elevation views, respectively, of a cylinder containment unit 400 (hereinafter unit 400) according to a fourth exemplary embodiment of the invention.

The unit 400 includes a support structure 404 for supporting the weight of one or more gas cylinders (not shown). Support structure 404 includes four base members 406 (e.g., legs) for contacting a floor surface (not shown). Each base member 406 includes an aperture 431 sized to receive a bolt (not shown) for mounting to a floor surface. A vertical member 408 is mounted to each base member 406 to extend substantially perpendicular with respect to base member 406. Two (2) cross-members 407 are mounted between adjacent vertical members 408. The support structure 404 may include any number or arrangement of members 406, 407 and 408.

Members 406, 407 and 408 are optionally welded together for enhanced structural integrity. It should also be understood that members 406, 407 and 408 may be fastened together in any fashion known in the art.

Four (4) shelves 410A-D (referred to herein as 410 collectively), which are each similar to shelf 110, are positioned about a perimeter of support structure 404. Each shelf 410 is releasably mountable to a side of support structure 404. One or more gas cylinders are positioned on a flat surface of each shelf 410. Each shelf 410 includes two hand grips 111 positioned on opposing sides thereof for handing shelf 410, and two brackets 412 for mounting to support structure 404.

As best shown in FIGS. 4A and 4B, each shelf 410 may be selectively positioned at any desired height elevation H1-H5 along support structure 104. The height elevation H1, H2, H3, H4 or H5 (see FIG. 4D) ultimately selected by the user is dependent upon the height of one or more cylinders (not shown). Alternatively, a shelf 410 may be stored when not in use. The support structure 404 includes hangers 440 positioned on each side thereof for mounting a shelf 410 that is not in use (see FIG. 4E).

Similar to unit 100, each shelf bracket 412 includes shelf mounting means, such as two posts (not shown, but similar to posts 113) for mounting to support structure 404. The support structure 104 includes shelf receiving means, in the form of apertures 414 (same as apertures 114) that are configured to be releasably engageable with the posts (or other shelf mounting means). The apertures 414 are formed in vertical members 408 and positioned along the height elevation H1-H5 thereof. Each shelf 410 is installed and removed from support structure 404 in the same fashion as the first embodiment illustrated in FIGS. 1A-1E.

Similar to unit 200, a series of flanges 430 and 431 extend from support structure 404. Two (2) flanges 430 extend from each side of support structure 404, while a flange 431 extends from each corner of support structure 404, as best shown in FIG. 4C. Each flange 430 and 431 includes an aperture 432 sized to receive one or more chains (not shown). The chain may be fastened to itself or aperture 432 for retaining cylinders in a fixed position. Although not shown, a padlock may secure each chain. A chain may be positioned through each aperture 432 about the entire perimeter of support structure 404, and fastened to itself with a pad lock.

The unit 400 includes twelve (12) containment spaces ‘S’ (one containment space ‘S’ shown in FIG. 4C). Each containment space ‘S’ preferably holds a single gas cylinder. Each containment space ‘S’ is bounded by a chain (not shown) and two adjacent flanges 430 and/or 431. The chains retain the gas cylinders within their respective containment space ‘S’.

Similar to the previously described units, unit 400 presents a safe and convenient structure for storing gas cylinders. Unit 400 is particularly advantageous by virtue of its ability to store a large number of gas cylinders. According to one aspect of the invention, unit 400 is adapted to store and retain twelve (12) cylinders, i.e., three (3) cylinders per shelf 410. Additionally, the gas cylinders may be stored at five different height elevations H1-H5.

While preferred embodiments of the invention have been described herein, it will be understood that such embodiments are provided by way of example only. Numerous variations, changes and substitutions will occur to those skilled in the art without departing from the spirit of the invention. For example, the containment units described herein are not limited for use with pressurized gas cylinders. The units may also be useful for storing any other desired device.

It is intended that the appended claims cover all such variations as fall within the spirit and scope of the invention.

What is claimed:

1. A pressurized cylinder containment unit comprising:
a support structure including means for receiving a shelf, said shelf receiving means defined along at least a portion of a height dimension of the support structure; and
at least one shelf for supporting the one or more pressurized cylinders, said at least one shelf being moveably positionable along the height dimension of the support structure, said at least one shelf including mounting means for selectively mounting to the shelf receiving means of the support structure at different height elevations.

2. The pressurized cylinder containment unit of claim 1, wherein the support structure comprises a base member for contact with a floor surface and a vertical member mounted to the base member, said shelf receiving means being defined along the vertical member.

3. The pressurized cylinder containment unit of claim 1, wherein the shelf is releasably coupled to the support structure.

4. The pressurized cylinder containment unit of claim 1, wherein the shelf receiving means comprises a plurality of apertures defined along the height dimension of the support structure.

5. The pressurized cylinder containment unit of claim 4, wherein the mounting means of the shelf comprises a post for insertion through an aperture defined in the support structure.

6. The pressurized cylinder containment unit of claim 1 further comprising an arm moveably coupled to the support structure, wherein the arm is moveable between an open position for providing selective access to the one or more pressurized cylinders positioned within the containment space and a closed position for retaining the pressurized cylinders within the containment space.

7. The pressurized cylinder containment unit of claim 1 further comprising a plurality of shelves, each shelf being configured to support at least one pressurized cylinder.

8. The pressurized cylinder containment unit of claim 1, further comprising a user control interface provided on the support structure, said user control interface including instruments for distributing fluid from the pressurized cylinders.

9. The pressurized cylinder containment unit of claim 8, further comprising a fluid carrying hose positioned in fluid communication between the user control interface and at least one of the pressurized cylinders.

10. A pressurized cylinder containment unit comprising:
a support structure defining a containment space for accommodating one or more pressurized cylinders;
an arm moveably coupled to the support structure, wherein the arm is moveable between an open position for providing selective access to the one or more pressurized cylinders positioned within the containment space and a closed position for retaining the pressurized cylinders within the containment space.

11. The pressurized cylinder containment unit of claim 10, wherein the arm is pneumatically actuated.

12. The pressurized cylinder containment unit of claim 10, wherein the support structure comprises a base member for contact with a floor surface and a vertical member mounted to the base member, said arm being mounted to said vertical member.

13. The pressurized cylinder containment unit of claim 10, wherein the arm is selectively mountable along a height dimension of the support structure.

14. A pressurized cylinder containment unit for housing multiple pressurized cylinders, said unit comprising:
a support structure defining a plurality of containment spaces, each containment space sized to accommodate at least one pressurized cylinder; and
a plurality of shelves for supporting multiple pressurized cylinders, wherein each shelf corresponds to one or more containment spaces, each shelf being mountable to the support structure at different height elevations.

15. The pressurized cylinder containment unit of claim 14, said shelves being mountable to the support structure about a perimeter of the support structure.

16. The pressurized cylinder containment unit of claim 14, wherein the support structure includes means for receiving each shelf, said shelf receiving means defined along at least a portion of a height dimension of the support structure for receiving each shelf at different height elevations.

17. The pressurized cylinder containment unit of claim 16, wherein each shelf includes mounting means for selectively mounting to the shelf receiving means of the support structure.

18. The pressurized cylinder containment unit of claim 17, wherein the shelf receiving means comprises a plurality of apertures defined along the height dimension of the support structure, and the mounting means of the shelf comprises a post for insertion through an aperture defined in the support structure.

19. The pressurized cylinder containment unit of claim 14, wherein each shelf is releasably coupled to the support structure.

20. The pressurized cylinder containment unit of claim 14, further comprising one or more flanges mounted to the support structure for retaining the cylinders within their respective containment space.
